(19) United States
(12) Patent Application Publication
(10) Pub. No.: US 2020/0341497 A1
(43) Pub. Date: Oct. 29, 2020

(54) INSTRUMENTED THERMOSTATIC CONTROL DEVICE AND MIXER TAP COMPRISING SUCH A THERMOSTATIC CONTROL DEVICE

(71) Applicant: VERNET, OLLAINVILLE (FR)

(72) Inventors: Christian MACE, BRUYERES LE CHATEL (FR); Benoît MAUGERARD, BRUNOY (FR)

(21) Appl. No.: 16/961,477

(22) PCT Filed: Jan. 11, 2019
(86) PCT No.: PCT/EP2019/050615

§ 371 Date: Jul. 10, 2020

(30) Foreign Application Priority Data
Jan. 12, 2018 (FR) 1850276

(51) Int. Cl. G05D 23/13; E03C 1/05; F16K 11/00; F16K 31/02; F16K 37/00; G01F 1/90; G01F 15/06

(52) U.S. Cl. CPC G05D 23/134; E03C 1/055; F16K 19/006; G01F 15/063; F16K 37/005; G01F 1/90; F16K 31/025

(57) ABSTRACT

A thermostatic control device for a thermostatic mixer tap has a temperature sensor that measures the temperature of a mixed fluid, a flow rate sensor that measures the flow rate of the stream of the mixed fluid when the control device is in a flowing state, and an incorporated electronic circuit having a programmable electronic computer, a communication interface provided with a radio antenna, and an electric energy reserve, capable of powering the electronic computer and the communication interface. The electronic circuit collects information measured by the sensors and transmits this information to the outside via the communication interface.

### PRIORITY AND CROSS REFERENCE TO RELATED APPLICATIONS

This application is the U.S. National Phase application under 35 U.S.C. § 371 of International Application No. PCT/EP2019/050615, filed Jan. 11, 2019, designating the U.S. and published as WO 2019/138027 A1 on Jul. 18, 2019, which claims the benefit of French Application No. FR 1850276, filed Jan. 12, 2018. Any and all applications for which a foreign or a domestic priority is claimed is/are identified in the Application Data Sheet filed herewith and is/are hereby incorporated by reference in their entireties under 37 C.F.R. § 1.57.

### FIELD

The invention generally relates to the field of household distribution installations for a fluid, in particular for water distribution.

### BACKGROUND

Thermostatic mixer taps make it possible to mix two fluid streams having different temperatures, such as a hot fluid stream and a cold fluid stream.

### SUMMARY

The present invention relates to an instrumented thermostatic control device, a thermostatic assembly including this thermostatic control device, as well as a thermostatic mixer tap equipped with such an assembly.

### BRIEF DESCRIPTION OF THE DRAWINGS

The invention will be better understood, and other advantages thereof will appear more clearly, in light of the following description of one embodiment of an instrumented thermostatic control device, provided solely as an example and done in reference to the appended drawings, in which:

FIG. 1 is a schematic illustration of a mixer tap equipped with an instrumented thermostatic control device according to embodiments of the invention;

FIG. 2 is a block diagram of a thermostatic control device according to embodiments of the invention;

FIGS. 3 and 4 are sectional views of a portion of a thermostatic control device according to a first embodiment of the invention;

FIGS. 5 and 6 are sectional views of a portion of a thermostatic control device according to a second embodiment of the invention;

FIGS. 7 and 8 are sectional views of a portion of a thermostatic control device according to a third embodiment of the invention.

### DETAILED DESCRIPTION

Thermostatic mixer taps make it possible to mix two fluid streams having different temperatures, such as a hot fluid stream and a cold fluid stream. This mixing results from an outgoing stream of fluid that has an intermediate temperature. The value of the intermediate temperature is adjustable by a user.

To that end, the mixer tap includes a thermostatic control device. This thermostatic control device includes means for mixing fluids and means for controlling the temperature of the mixed fluid.

One example of a known thermostatic control device is described in patent FR-2,821,411-B1.

Typically, these mixer taps make it possible to supply fluid to a sanitation facility, such as a shower, sink, washbasin or bathtub.

With the development of home automation applications, there is now a need for mixer taps that are capable of collecting usage data, for example the quantity of water consumed or the fluid temperatures involved, and sending these data to a receiver outside the mixer tap, preferably by a wireless link. These new functionalities must not, however, deteriorate the working of the mixer tap, in particular regarding its durability and the safety of users, or complicate the integration of the mixer tap into existing facilities.

There is therefore a need for an instrumented thermostatic control device for a mixer tap that is capable of meeting the aforementioned needs.

To that end, the invention relates to a thermostatic control device for a thermostatic mixer tap, the control device being configured to produce a fluid stream mixed from two hot and cold fluid streams, characterized in that the control device is instrumented and to that end includes:
a temperature sensor for measuring the temperature of the mixed fluid;
a flow rate sensor for measuring the flow rate of the stream of mixed fluid when the control device is in a flowing state;
an electronic processing circuit, embedded in the control device and comprising:
   a programmable electronic computer,
   a communication interface provided with a radio antenna,
   an electric energy reserve, capable of powering the electronic computer and the communication interface;
      and in that the electronic circuit is suitable for collecting the information measured by the sensors and for transmitting this information to the outside via the communication interface.

Owing to the invention, the thermostatic control device is capable of collecting usage data and transmitting this data via an outside receiver. These collection and transmission functionalities are thus provided in an integrated manner in the device, without it being necessary to use a hardwired connection and/or to physically connect additional equipment items to the outside of the mixer tap.

According to advantageous but optional aspects of the invention, such a thermostatic control device may incorporate one or more of the following features, considered alone or according to any technically allowable combination:
The flow rate sensor is a hydraulic turbine suitable for electrically powering the energy reserve, such as an axial micro-turbine.
The control device includes a hydraulic turbine, such as an axial micro-turbine, suitable for electrically powering the energy reserve and the flow rate sensor is separate from said hydraulic turbine.
The communication interface is compatible with a short-range wireless communication technology.
The control device further includes a temperature sensor for measuring the temperature of the cold fluid.
The electronic processing circuit is programmed to calculate the energy necessary to heat a volume of cold fluid upstream from the thermostatic control device in particular as a function of the measured flow rate, the temperature of the mixed fluid and the temperature of the cold fluid measured by said temperature sensor.
The electronic processing circuit is programmed to calculate the energy necessary to heat a volume of cold fluid upstream from the thermostatic control device in particular as a function of the measured flow rate, the temperature of the mixed fluid and a predefined temperature value of the cold fluid.
The energy reserve includes one or several supercapacitors.
The electronic circuit is at least partially housed inside an inner housing delimited by a body of the control device, this housing being tightly protected from the fluid streams.
The electronic computer is programmed to transmit one or several of the usage data chosen from among the group containing the following data:
   the evolution of the mixed fluid temperature over time, coming from the measurement by the temperature sensor;
   the sending of an alert if the mixed fluid temperature exceeds a predefined threshold;
   the evolution of the mixed fluid flow rate coming from the measurement by the flow rate sensor;
   the sending of an alert if the mixed fluid flow rate exceeds a predefined threshold;
   the thermal power provided by an associated hot fluid production device in order to heat the cold fluid;
   the thermal energy corresponding to the thermal power provided by the production device during a usage cycle of the tap;
   an estimate of the financial cost associated with the production of the thermal energy E for the usage cycle,
   start and/or end date and time of the usage cycle;
   duration of the usage cycle;
   average, minimum and maximum values of the mixed fluid temperature during the usage cycle;
   average, minimum and maximum values of the mixed fluid flow rate during the usage cycle;
   volume of water consumed during the usage cycle.
The electronic computer is programmed to store, in permanent memory, statistical data representative of the use of the tap.

The invention also relates to a thermostatic control assembly for a thermostatic mixer tap, this assembly comprising:
a thermostatic control device for producing a stream of mixed fluid from two streams of hot and cold fluid;
a device for controlling the mixed fluid flow rate;
   characterized in that the thermostatic control device [is] as previously described.

The invention also relates to a thermostatic mixer tap, comprising:
a mixer tap body;
a hot fluid inlet, a cold fluid inlet and a mixed fluid outlet;
a thermostatic control device positioned inside the body and fluidly connected to the fluid inlets and the fluid outlet;
   the mixer tap being characterized in that the thermostatic control device is as previously described.

According to advantageous but optional aspects of the invention, such a thermostatic mixer tap may incorporate one or more of the following features, considered alone or according to any technically allowable combination:
The control device is integrated into an assembly including a main body and a control device of the fluid flow rate, the assembly being positioned inside the tap body coaxially with this tap body, while the main body is separated from the inner walls of the tap body by a dry area, and the device includes an electrical connection that connects the electronic circuit to the sensors, this electrical connection being positioned in the dry area.
The control device is integrated into an assembly including a main body and a control device of the fluid flow rate, the assembly being positioned inside the tap body, and the electronic processing circuit associated with the control device is inside the main body.

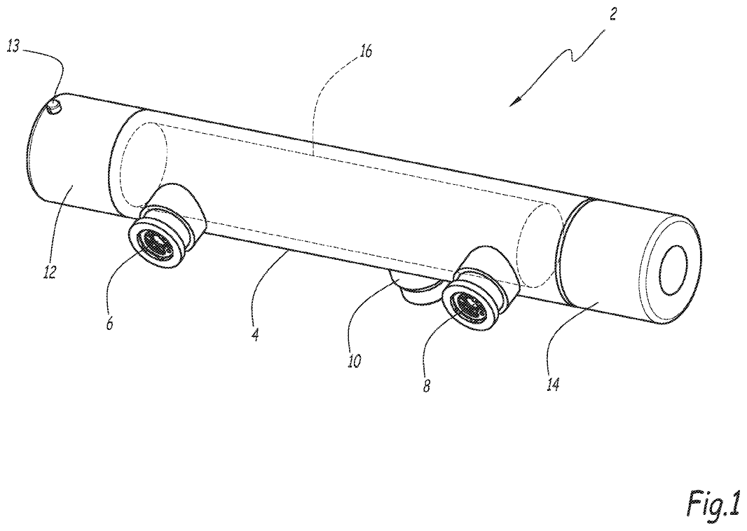

FIG. 1 shows an exemplary thermostatic mixer tap 2 for dispensing a fluid, such as water.

The dispensed fluid, called “mixed fluid”, is obtained by mixing a stream of hot fluid and of cold fluid.

For example, the mixer tap 2 is configured to be mounted in a domestic supply water distribution installation, such as a shower, a bathtub, a washbasin or a sink.

In this embodiment, the mixer tap 2 includes a body 4, a hot fluid inlet 6, a cold fluid inlet 8 and a mixed fluid outlet 10, a rotary button 12 for adjusting the temperature and a rotary button 14 for adjusting the mixed fluid flow rate exiting through the outlet 10.

For example, the body 4 has a hollow tubular shape extending along a longitudinal axis. The buttons 12 and 14 are mounted on opposite ends of the body 4, coaxially with respect to the body 4, and are rotatable around this longitudinal axis.

Optionally, the button 12 is provided with a locking member 13 that can be actuated manually and selectively makes it possible to lock the rotation of the button 12. The button 14 can also be provided with a similar locking member.

The mixer tap 2 can alternately be in a so-called “flowing” state in which the mixed fluid exits through the outlet 10, or in a so-called “non-flowing” state, in which no fluid flows through the outlet 10, even when the mixer tap 2 is supplied with fluid through the inlets 6 and 8.

The mixer tap 2 to that end comprises a control device for the fluid flow rate, controlled by the rotary button 14, which makes it possible to interrupt, or alternately allow, the flow of fluid in the mixer tap 2 in order to switch the latter selectively between the flowing and non-flowing states. For example, the control device of the flow rate is a system with ceramic discs.

The mixer tap 2 also includes a thermostatic control device 16, housed inside the mixer tap 2, for example in the body 4.

The device 16 makes it possible to mix the streams of hot and cold fluid coming from the inlets 6 and 8 in order to obtain a stream of mixed fluid, the temperature of which corresponds to a control temperature chosen by a user using the button 12.

The device 16 is said to be “thermostatic” in that it makes it possible to control the temperature of the mixed fluid at a constant and adjustable value, independently of respective pressure and temperature variations of the entering hot and cold fluids and the outgoing fluid flow rate, within a certain pressure and flow rate range.

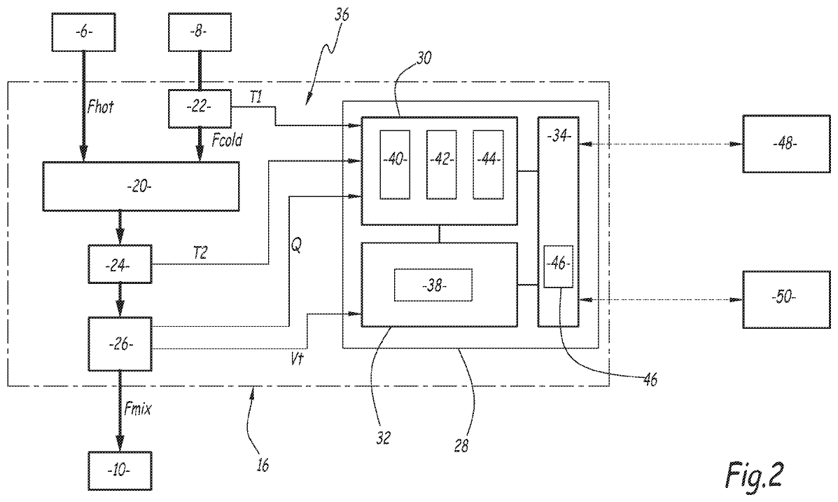

FIG. 2 shows an example of the device 16, illustrated in a simplified manner.

The device 16 comprises a hot fluid inlet, a cold fluid inlet and a mixed fluid outlet. These inlets and this outlet are respectively placed in fluid communication with the inlets 6, 8 and the outlet 10 when the device 16 is mounted inside the mixer tap 2.

Hereinafter, in order to simplify the description, the fluid inlets of the mixer tap 2 are combined with those of the control device 16. The latter therefore do not bear any numerical reference and are not described in detail.

Reference “Fhot” denotes the hot fluid stream coming from the inlet 6, “Fcold” denotes the cold fluid stream coming from the inlet 8, and “Fmix” denotes the mixed fluid stream that results from mixing streams Fhot and Fcold, the stream Fmix being intended to exit through the outlet 10.

By extension, the distinction between flowing state and non-flowing state also applies to the device 16 in the rest of the description.

According to embodiments, the device 16 includes an elongate body extending along the longitudinal axis X16. For example, when the device 16 is mounted in the body 4, the longitudinal axis X16 is parallel to, or even combined with, the longitudinal axis of the body 4.

For example, the body of the device 16 is made from plastic.

According to embodiments, the device 16 is intended to be associated with the control device for the fluid flow rate previously defined in order to form a thermostatic assembly, or thermostatic whole, intended to equip the mixer tap 2.

The device 16 includes an apparatus 20 for mixing the streams Fhot and Fcold and controlling the temperature of the mixed fluid Fmix.

The apparatus 20 here is mechanically coupled to the button 12 for allowing a user to select a control temperature.

For example, this apparatus 20 is made by thermostatic control components of the thermomechanical type, such as using a preassembled thermostatic cartridge.

The role and the working of such thermostatic control components of the thermomechanical type are known and in patents FR 2,774,740, FR 2,869,087 and FR 2,921,709 filed in the name of the company VERNET SA.

The device 16 here is said to be instrumented, in that it further includes electronic measuring and processing means in order to collect and transmit data relative to the use of the mixer tap 2.

The device 16 thus includes a first temperature sensor 22 in order to measure the temperature T1 of the cold fluid stream Fcold, a second temperature sensor 24 in order to measure the temperature T2 of the mixed stream Fmix, a sensor 26 in order to measure the flow rate Q of the mixed stream Fmix, and an electronic processing circuit 28.

The electronic circuit 28 includes a programmable electronic computer 30, an electrical power circuit, also called power stage 32, and a radiocommunication interface 34, as well as an electrical connection 36.

The power stage 32 includes an energy reserve 38. The computer 30 here includes a logic computing unit 40, a computer memory 42 and an electronic clock 44. The interface 34 includes a radio antenna 46. The interface 34 in particular makes it possible to provide a communication between the circuit 28 and a user terminal 48, or with a remote computer server 50.

Hereinafter, the term “user device” is used to refer to one or the other of the user terminal 48 and the remote computer server 50.

The circuit 28 is intended to collect the information measured by the sensors of the device 16 and to send this information to the outside of the tap 2, for example to the devices 48 or 50, using the communication interface 34.

The electrical connection 36 electrically connects the circuit 28 with at least part of the sensors associated with the circuit 28, in particular with the sensors 24 and 26. It in particular makes it possible to convey energy and transmit data.

Thus, the sensors 22, 24 and 26 and the circuit 28 together form the electronic measuring and processing means previously mentioned.

It will in particular be understood that the circuit 28 here does not provide the thermostatic control, the latter being ensured by the apparatus 20.

The components of the circuit 28 are described in more detail hereinafter in reference to FIG. 2.

Preferably, the second temperature sensor 24 is a temperature probe using ceramic technology with a negative temperature coefficient. This technology has the advantage of being reliable and economical.

According to embodiment variants, the first temperature sensor 22 can be omitted. However, when it is present, the temperature sensor 22 preferably uses a technology similar to that of the temperature sensor 24.

In a variant, the temperature sensor 24 is a thermocouple.

The second temperature sensor 24 here is located downstream from the apparatus 20, while the first temperature sensor 22 is located upstream from the apparatus 20 after the inlet 8. The terms “downstream” and “upstream” are defined relative to the direction of flow of the fluid streams toward the outlet 10.

The flow rate sensor 26 is suitable for measuring the flow rate Q of the mixed fluid stream Fmix at the outlet of the apparatus 20, before this stream leaves the system 16 of the tap 2 through the outlet 10.

Preferably, the sensor 26 is a turbine flowmeter, arranged in the device 16 so as to be passed through by the fluid stream Fmix when the tap 2 is in the flowing state.

The use of a turbine flowmeter is particularly advantageous, since this makes it possible to generate energy from the fluid flow Fmix. In other words, the sensor 26 serves both as flow rate sensor and energy generator. The energy thus generated is used to power the stage 32 and in particular to recharge the energy reserve 38.

For example, the turbine 26 generates an electrical voltage, denoted “Vt”, when the fluid stream Fmix circulates through the turbine 26. This voltage is used both as an electrical power source and as a signal providing information on the flow rate Q, as explained below.

In the description that follows, when the sensor 26 is a turbine flowmeter, it is designated by the term “turbine 26”.

Particularly preferably, the turbine 26 is an axial micro-turbine.

For example, such an axial micro-turbine comprises a hollow cylindrical body forming a stator and a rotor provided with one or several blades arranged inside the stator and able to rotate about an axis of rotation corresponding to the longitudinal axis of the stator. The rotor is then rotated when the fluid Fmix circulates through the micro-turbine. The micro-turbine also comprises an electromechanical circuit for generating an electrical output voltage when the rotor rotates. The rotation axis of the rotor here is combined with the longitudinal axis X16.

Preferably, the second temperature sensor 24 is integrated inside the turbine 26.

An example of one such turbine 26 of the axial micro-turbine type is the axial micro-turbine manufactured by the company TOTO and described in JP 2007-274858 A.

The use of an axial micro-turbine is advantageous, since it offers a good compromise between the bulk of the turbine 26 and the quality of the electrical voltage signal supplied by the turbine, in particular to obtain a satisfactory linearity of the signal despite the variations of the flow rate and the hydraulic fluid head loss.

As an example, the measurement of the flow rate Q is done indirectly, using calculations, from characteristics of the measured electrical signal delivered by the turbine 26 (characteristics such as the frequency and/or the amplitude and/or the instantaneous power) and/or characteristics of the charge power received by the power stage 32, these calculations using predefined relationships, for example algebraic relationships or prerecorded maps.

For example, the calculation is done using the computer 30.

In a variant, this processing is done by a dedicated logic or analog circuit integrated within the turbine 26, such that a signal representative of the flow rate Q is simply collected on an appropriate output of the turbine 26 independently of the voltage Vt.

According to alternative embodiment variants of the invention, the turbine 26 is omitted. The flow rate sensor 26 is then not necessarily able to generate energy.

According to other variants, not illustrated, the control device includes a hydraulic turbine, for example similar to the turbine previously described, that only serves to provide electrical power to supply electricity to the energy reserve 38, the flow rate measurement being provided by a dedicated flow rate sensor 26 that is separate from said turbine.

For example, the sensor 26 is an ultrasound flowmeter, or an electromagnetic flowmeter, or a differential pressure sensor associated with a device of the “Pitot tube” or “Venturi tube” type.

Optionally, the device 16 can include an additional flow rate sensor, not illustrated, able to measure the flow rate Q and intended to back up the sensor 26. Indeed, in practice, when a turbine is used as sensor 26, the turbine may not rotate when the flow rate of the stream Fmix is below a startup threshold, which in particular depends on the remanent electromagnetic torque of the turbine. Means exist for reducing this startup threshold, but they have the result of reducing the electrical power supplied by the turbine.

Thus, if a satisfactory compromise cannot be found, the additional flow rate sensor makes it possible to measure the flow rate Q during startup phases in which the turbine 26 does not rotate. Preferably, this additional sensor is next no longer used once the flow rate of the stream Fmix becomes sufficient to allow the turbine 26 to rotate. The circuit 28 is adapted accordingly to process the additional signal supplied by this flow rate sensor.

For example, this additional flow rate sensor is made by using the flow rate sensor described in application FR 3,019,876 A1. In a variant, it is possible to use one of the alternative flowmeter technologies described above. The additional flow rate sensor is for example placed in series with the turbine 26 relative to the flow of the fluid Fmix.

The power stage 32 is now described in reference to FIG. 2. It is intended to supply power to the components of the electronic circuit 28, and in particular to supply power to the computer 30 and the interface 34 with a conditioned and stabilized electric voltage, such as a direct voltage, for example a direct voltage with amplitude equal to 3.3 volts.

To that end, the power stage 32 includes at least one power converter for converting the alternating voltages received from the turbine 26 into direct voltages able to be stored in the energy reserve 38 and/or to power the other components of the circuit 28 directly.

For example, the power stage 32 comprises a first AC/DC power converter of the rectifier type, in order to convert the electric voltage supplied by the turbine 26 into a direct voltage that supplies the energy reserve 38, and a second DC/DC power converter of the step-up type, in order to convert the electric voltage available across the terminals of the energy reserve 38 into a stabilized direct voltage intended to power the rest of the circuit 28.

In a variant, the power converter(s) can be integrated into a dedicated power circuit associated with the turbine 26.

In embodiments where the sensor 26 is not a turbine and is not able to generate energy, then the power stage 32 and the power converter(s) are adapted accordingly.

In this example, the energy reserve 38 includes at least one supercapacitor 381, preferably several supercapacitors 381.

Using supercapacitors is advantageous because they have a small bulk and a greater lifetime relative to batteries. Indeed, in practice, the energy reserve 38 experiences a large number of charge and discharge cycles over time, these cycles being repeated with a high usage frequency, corresponding to the usage frequency of the mixer tap 2. For example, in a household sanitation installation, such a mixer tap 2 can be opened, then closed several tens of times, or even several hundreds of times in the space of a single day. The lifetime of supercapacitors is deteriorated less by such a repetition of cycles than the duration of the known batteries.

Additionally, according to optional and advantageous embodiments, the reserve 38 further includes a non-rechargeable cell 382, intended to be used to power essential functions of the circuit 28 when the supercapacitor(s) are run down.

Such a cell has the advantage of having a small bulk. Its non-rechargeable nature is not prohibitive, inasmuch as it is only intended to be used in a secondary manner, only as backup when the supercapacitor(s) are run down, and additionally to power the circuit 28 when it is only performing essential functions, the latter requiring less energy than the nominal functions of the circuit 28.

One will thus understand that in certain embodiments, the reserve 38 is formed by the combination of several energy storage means with different technologies, which can be used independently of one another as a function of the circumstances, to power all or part of the circuit 28.

Advantageously, the power stage 32 includes an energy management device, not illustrated, intended to control the access to and operation of the reserve 38, in particular during recharging phases of the reserve 38. The energy management device is for example made using a dedicated device, for example by programmable logic circuit or by any other equivalent means, preferably separate from the computer 30.

In a variant, these functions are performed by the computer 30.

Advantageously, the circuit 28 can be switched between a normal operating mode and a standby mode, in which certain functions of the circuit 28 are deactivated, in order to reduce the electricity consumption.

This makes it possible to optimize the electrical consumption of the circuit 28 and therefore to preserve the autonomy of the energy reserve 38.

The standby mode is activated when the mixer tap 2 is not in use, for example after an elapsed time in the non-flowing state exceeding a predefined threshold. However, other management strategies are possible.

The circuit 28 is thus suitable for being “woken up”, that is to say, switched from its standby mode to its normal operating mode, automatically when the mixer tap 2 goes from the non-flowing state to the flowing state.

According to one example, the management functions of the normal operating mode or standby mode are performed by the energy management device previously described.

For example, this energy management device is suitable for detecting the flowing state or non-flowing state from flow rate information Q supplied by the turbine 26, or more generally, supplied by the sensor 26.

According to other embodiment variants of the invention, the supercapacitors 381 are omitted. The energy reserve 38 includes, in their place, a rechargeable electric battery, for example using lithium-ion technology, or nickel metal hydride technology This battery is preferably used in conjunction with the turbine 26, so as to be recharged by the turbine 26. However, in a variant, it may be associated with other recharging means.

According to still other variants, the energy reserve 38 is a non-rechargeable electric battery, such as an electric cell using Lithium-MnO₂ technology or Lithium-SOCl₂ technology. In other words, the energy reserve 38 can then not be recharged.

According to still another variant, the power stage 32 is configured to be supplied with electricity by an electric grid of the sector type. When the energy reserve 38 is at least partially rechargeable, the recharging is then done owing to the energy supplied by this electric grid.

An exemplary electronic computer 30 is now described in reference to FIG. 2.

The logic unit 40 here is a microprocessor or a programmable microcontroller.

In this example, the memory 42 comprises a non-volatile memory, for example a memory module of the Flash type or any other equivalent technology. The memory 42 may further include a volatile working memory of the RAM (Random Access Memory) type.

The memory 42 stores software instructions that are executable to ensure the working of the computer 30 and the circuit 28 when these instructions are run by the logic unit 40. For example, these executable instructions form firmware, or an embedded system, of the computer 30.

In general, the computer 30 is programmed to collect the data coming from the sensors and to store them in memory, or to reprocess them, before sending them to the device 48 or 50.

According to one aspect, the computer 30 is preferably at least programmed to provide values of the following physical properties, from raw data measured using the sensors 22, 24 and 26: the temperature T2 of the mixed fluid, the flow rate Q of the mixed fluid, or even the temperature T1 of the cold fluid, for each instant t during which the device 16 is in the flowing state.

These values are for example instantaneous values or values averaged over a predefined time interval, for example over a usage cycle of the mixer tap 2.

Within the meaning of the present disclosure, “usage cycle” refers to a series of flowing and non-flowing states of the tap 2, this series for example being implemented by a user to perform a specific use.

For example, a usage cycle begins when the tap 2 is actuated toward the flowing state after having stayed in the non-flowing state for a duration exceeding a predefined threshold, called “stop duration threshold”. The usage cycle ends at the end of the last flowing state, that is to say, the first flowing state to be followed by a non-flowing state with a duration greater than or equal to the stop duration threshold.

In other words, two consecutive uses of the tap 2 separated by a pause during which the tap is not used, that is to say, during which it is in the non-flowing state, while these two uses are considered to be part of the same usage cycle if the pause duration is short enough.

As an illustrative example, a usage cycle may correspond to a shower taken by the user, this shower being able to be interrupted by periodic stops of limited duration.

The calculation of the measuring instants t and the counting of the durations are done here owing to the clock 44.

According to another aspect, the computer 30 is advantageously programmed to allow the real-time calculation of the quantity of energy, denoted E, necessary to heat the hot fluid for a specific use, for example to make it possible to take a shower.

For example, the energy E corresponds to the energy necessary to heat a volume of cold water in order to have enough hot water for a user to be able to take a shower.

It is understood that, for the different described embodiments, the case of a shower is provided as a non-limiting example and that the computer 30 can also be programmed to implement such calculations for types of applications other than a shower, and in particular for fluids other than water.

This functionality is particularly advantageous when the tapped 2 is intended to be part of a water distribution installation including a household hot water production device, such as a water heater or a hot water tank, controlled by a control system, for example home automation.

Such a hot water production device works by heating the cold water that typically comes from a same source as that supplying the inlet 8. It will be understood that this hot water production device is located upstream from the inlet 8 of the tap 2.

The information collected owing to the device 16 is thus used by the home automation control system in order to control the hot water production device, so as to optimize the energy consumption.

According to a first possibility, the computer 30 directly calculates the energy E in real time from measured data and as a function of predefined formulas.

According to another possibility, the computer 30 does not directly calculate the energy E, but instead calculates intermediate properties. These intermediate properties are next used by an outside calculating device, for example within the home automation control system, to calculate the energy E.

For example, the properties X and Y defined below are calculated automatically by the computer 30, for example in real time for each usage cycle:

$$X = {\sum }_{i = 1}^{n} T {m}_{i} \times {Q}_{i}$$

$$and$$

$$Y = {\sum }_{i = 1}^{n} {Q}_{i}$$

where “i” is an index identifying each measurement sampling, “n” is a number equal to the total number of measurements samples for the usage cycle, “Tmi” is the temperature value T2 for the instant corresponding to the measurement sample i, and “Qi” is the flow rate value Q the instant corresponding to the measurement sample i.

The energy E is then calculated separately, from these properties X and Y and from information on the cold water temperature value upstream from the hot water production device.

For example, the energy E is calculated using the following formula:

E=Q×Cv×(X−Y×Tfe)

where Cv is the volumetric heat capacity of the water.

According to one variant, the computer 30 is advantageously programmed to estimate the cold water temperature “Tfe” upstream from the hot water production device.

In practice, this temperature Tfe can differ from the cold fluid temperature T1 measured by the first temperature sensor 22, especially when the tap 2 has stayed for a long time in the non-flowing state, hence the interest of not merely measuring the temperature T1.

Indeed, due to the heat exchanges with the environment, the cold water present in the tap 2 at the sensor 22 can have a substantially different temperature from that of the cold water that arrives upstream from the hot water production device, especially at the beginning of a usage phase of the tap 2.

According to a first example, the temperature Tfe for a usage cycle is estimated to be equal to the minimum temperature value T1 during this usage cycle.

According to a second example, the temperature Tfe is estimated to be equal to the minimum temperature value T1 measured during all of the usage cycles of the tap 2 during a predetermined duration, this duration being able to range from one day to several months.

In a variant, in place of the estimate, it is possible to instead use a preset temperature value Tfe, for example a parameter entered by a user, or a factory preset regional parameter. In a variant, if the home automation control system knows the temperature value Tfe of the cold water entering the production device, for example because the latter is measured using a dedicated temperature sensor, then this value can be supplied to the computer 30, no estimate then being necessary.

Thus, in general, the electronic processing circuit 28 is programmed to calculate the energy E as a function, in particular, of the measured flow rate, the temperature of the mixed fluid and the temperature of the cold fluid. The temperature of the cold fluid can, depending on the case, be measured by the first temperature sensor 22 or be a predefined value stored in memory, for example when the control device 16 is devoid of first temperature sensor 22.

According to another aspect, the computer 30 is advantageously programmed to calculated synthetic data and usage statistics of the tap 2, in particular from measured flow rate and temperature data as a function of time. These calculations are done as a function of preset rules and as a function of parameters that can be modified by the user.

As an example, the computer 30 is configured to store and/or calculate all or part of the following data relative to the real-time operation of the device 16, with a view to a transmission via the interface 34:
the evolution of the temperature T2 over time, coming from the measurement by the second sensor 24;
the emission of an alert if the temperature T2 exceeds a preset threshold;
the evolution of the flow rate Q, coming from the measurement by the sensor 26;
the emission of an alert if the flow rate Q exceeds a preset threshold;
the thermal power P supplied by the hot water production device in order to heat the cold water, this power P being calculated by the following formula:

P=Q×Cv×(T2−Tfe),

where Cv is the volumetric heat capacity of the water, this power being able to be instantaneous or averaged over a preset duration;
the thermal energy E corresponding to the thermal power P provided by the production device during a usage cycle;
an estimate of the financial cost associated with the production of the thermal energy E for the usage cycle, this estimate being calculated from the consumed volume of water, the consumed energy E and the unit cost scale previously defined and known by the computer 30.

As an example, the computer 30 is also configured to store and/or calculate all or part of the following synthetic data relative to a usage cycle:
start and/or end date and time of the usage cycle;
duration of the usage cycle;
average, minimum and maximum values of the temperature T2 during the usage cycle;
average, minimum and maximum values of the flow rate Q during the usage cycle;
volume of water consumed during the usage cycle.

For example, the so-called real-time data can be transmitted to the outside continuously during the usage cycle, but can also be stored before a later transmission. In contrast, the synthetic data relative to a usage cycle can only be fully calculated, then transmitted once the usage cycle is complete.

It will therefore be understood that, in general, the computer 30 can send the data to the outside in real time or on a deferred basis.

When data are not transmitted in real time, they are stored in memory by the computer 30 for later transmission. Preferably, they are erased after sending, so as to avoid saturating the memory 42.

According to another aspect, the computer 30 is advantageously programmed to implement a function of the “black box” type, by recording, in a permanent memory, for example in the memory 42, statistical data representative of the use of the tap. These data are intended to be used later in case of failure of the computer 30 and/or of the device 16, for example to analyze failure modes of the device 16 in case of breakdown, or to confirm or invalidate allegations in case of incident involving a user of the tap 2, for example in case of burn due to an excessively high fluid temperature.

In this example, the data recorded by the computer 30 include:
a unique identifier of the computer 30, for example comprising a serial number, a manufacturing lot number, a manufacturing date;
an identifier of the version of the embedded system used by the computer 30;
maximum and minimum values of the measured temperatures T2, and if applicable, T1, for different measuring instants over time;
maximum and minimum values of the measured flow rate Q, for different measuring instants over time;
the number of usage cycles of the device 16.

Preferably, the computer 30 is programmed to prevent the alteration of these recorded data by an unauthorized user.

The computer 30 can also send data relative to the electrical supply, such as statistics relative to the operation of the power stage 32 or a charge level of the energy reserve 38 and more specifically the charge level of the supercapacitor(s) and/or the non-rechargeable cell, if applicable.

According to another aspect, the computer 30 is advantageously programmed to implement a user access interface, which makes it possible to organize and control the data exchanges between the computer 30 and the terminal 48 or the server 50 when a connection is established using the interface 34. The user access interface thus allows an authorized user and/or a maintenance agent to access measured data and/or to change parameters, via a website (in the case of a remote server 50) or a dedicated application (in the case of the terminal 48).

The communication interface 34 is now described in reference to FIG. 2.

The interface 34 is suitable for communicating, owing to the antenna 46, according to one or several communication protocols of the short-range wireless type. Preferably, the “Bluetooth Low Energy” protocol is used here, which makes it possible to transfer a large volume of data and which is compatible with a large number of mobile communication devices.

In this way, the interface 34 can connect directly to a terminal 48 in order to exchange data once this terminal 48 includes a wireless communication interface of compatible technology and this terminal 48 is at a distance from the device 16 of less than or equal to the maximum range of the technology used.

For example, the terminal 48 is a mobile communication apparatus such as a mobile telephone, or a tablet, or a laptop computer.

In a variant, the terminal 48 is a specific terminal installed near the fluid distribution installation, for example a terminal installed in a shower stall in which the tap 2 is installed. This terminal is then preferably provided with a display screen in order to display, in real time, data relative to the use of the tap 2, in particular selected among those previously defined, such as the power P, the energy E or the financial cost.

According to other variants, the terminal 48 is a module able to be integrated into a home automation installation, for example able to be integrated into the hot water production device previously described or into the control system associated therewith. This integration makes it possible to facilitate the exchange of data, for example to adapt operating parameters of the device 16, such as the temperature Tfe.

In practice, the interface 34 can be connected to several devices 48 and/or 50 at once.

The interface 34 also allows a connection of the computer 30 to the remote server 50, by means of an intermediate connection device, or concentrator, which serves as a relay between the interface 34 and this remote server 50.

For example, this is useful in the case of a remote server 50 that is not directly accessible by means of said short-range communication protocol, but which is accessible by means of one or several other data exchange networks to which said intermediate connection device is connected. This may involve the Internet, or a machine-to-machine communication network, of the LoRaWAN type or the “ultra-narrowband” type, such as the SIGFOX® protocol. The intermediate connection device is in turn provided with a wireless communication interface using technology compatible with the interface 34 so as to be able to communicate therewith.

In some cases, the terminal 48 can act as intermediate connection device.

According to examples, the server 50 is suitable for collecting and analyzing the data transmitted by the device 16, with the aim of analyzing the consumption habits of the users. This analysis is for example done by a builder of the tap or the device 16, or by a service provider, or in the case of use in a collective residence, by a building manager.

The aim of this analysis is, for example, to provide a manufacturer or operator with the information making it possible to improve their products and services, or to provide users with information on their consumption with a view to encouraging them to optimize their water consumption.

According to another example, this analysis makes it possible to avoid household accidents and/or to intervene in case of such an accident. Thus, advantageously, when an alarm is generated by the computer 30, for example in case of excessively high temperature T2, an alert signal is sent to the terminal 48 or to the server 50. In response, the latter automatically notifies a personal assistance entity.

In practice, generally speaking, the exchange of data between the computer 30 and a user device 48 or 50 can be done either in a one-way communication mode (here from the computer 30 to a device 48 or 50), or in a two-way communication mode.

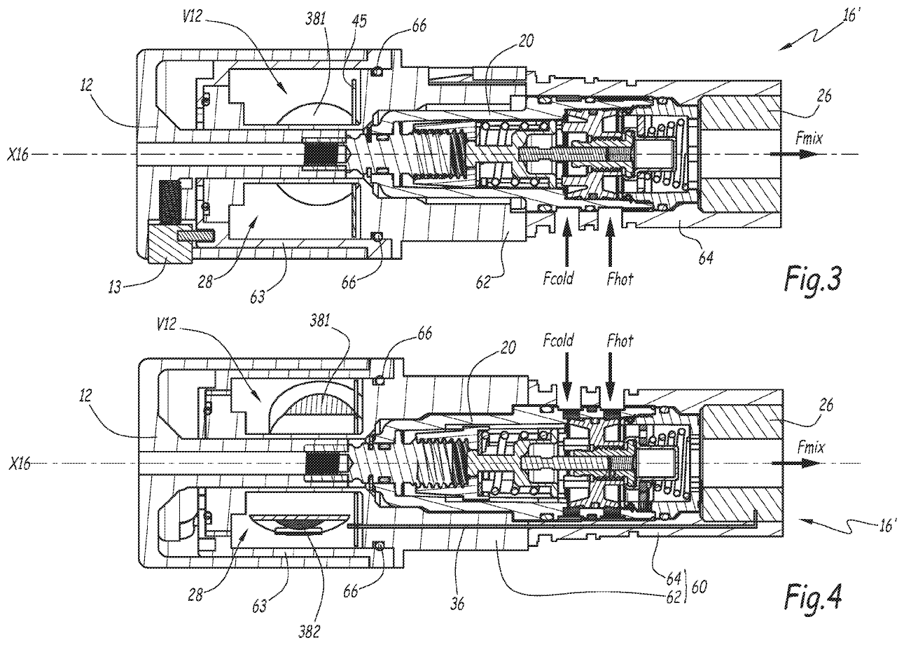

Embodiments of the physical integration of the circuit 28 within the device 16 are now described generically. Specific embodiments are illustrated in the examples of FIGS. 3 to 8.

Preferably, the computer 30 also includes an electronic board 45 including a PCB-type substrate on which the components of the computer 30 are mounted, such as the computer 40, the memory 42 and the clock 44, or even also the components of the power stage 32, and in particular the component(s) making up the energy reserve 38.

For example, the circuit 28 is integrated into the body of the device 16. In particular, the circuit 28 is advantageously positioned inside a housing arranged at a support of the rotary button 12.

For example, the substrate used in the electronic board 45 has a disc shape provided with a central orifice. As an illustrative example, the diameter of the disc-shaped substrate is between 3 cm and 5 cm. The diameter of the central orifice is between 1 cm and 2 cm.

According to embodiments, the device 16 has a cylindrical shape with longitudinal axis X16. In a mounted configuration, the board 45 is arranged perpendicular to this longitudinal axis X16. The central recess allows the passage of components of the device 16. For example, the board 45 is mounted coaxially around the longitudinal axis X16 with a rotatable coupling portion associated with the rotary button 12, this portion being able to enter the central orifice.

The connection 36 is preferably a hardwired connection. It can include cables or a preformed rigid tongue in which conductors are arranged.

For example, the connection 36 includes four conductors. Two of these conductors couple the turbine 26 to the electronic circuit 28, for example one for the electric ground and one for the electric phase, in order to deliver an electric current that powers the power stage 32 and for which information is extracted on the flow rate Q. Two others of these conductors couple the sensor 22 to the circuit 28, for example to perform a resistance measurement across the terminals of the sensor 22 when the sensor 22 is a probe with a negative temperature coefficient. Alternatively, the connection 36 includes a wired fieldbus, for example of the LIN (Local Interconnect Network) type.

The connection 36 is inserted into orifices arranged in the body of the device 16. Alternatively, it is overmolded during the manufacturing of the device 16.

According to variants, the sensor 22 is directly connected on the board 45. Thus, the sensor 22 is connected to the computer 30 independently of the connection 36.

The dimensions of the antenna 46 are adapted as a function of the technology used to carry out the communications with the devices 48 and 50.

For example, a half-wave dipole antenna or a quarter-wave antenna is used. For a technology of the Bluetooth Low Energy type operating at a frequency of 2.4 GHz, the length of the antenna is equal to 62.5 mm or 31.25 mm.

The arrangement of the antenna 46 in the device 16 is chosen so as to prevent the radio waves from being blocked by metal belonging to the tap 2, which would prevent the establishment of a communication with a device 48, 50 located outside the tap 2.

Preferably, the antenna 46 is mounted on the board 45. In a variant, however, it can be mounted outside the device 16. Such a variant can prove necessary when the device 16 is intended to be used in a tap 2 whereof the body 4 and/or the buttons 12 and 14 are covered with a decorative metal such as chrome or gold.

FIGS. 3 and 4 show a thermostatic control device 16′ according to a first specific embodiment of the invention.

The elements of the thermostatic control device 16′ that are similar to the embodiment of the thermostatic control device 16 previously described bear the same references and are not described in detail, inasmuch as the above description can be transposed to them.

More specifically, FIGS. 3 and 4 correspond to longitudinal sectional views of the device 16′ in different section planes.

The body of the device 16′ here bears reference 60. It comprises a first sleeve 62 and a second sleeve 64 between which the mixing and thermostatic control apparatus 20 is positioned. The sleeves 62, 64 and the apparatus 20 are positioned coaxially relative to the axis X16 and are mechanically connected to one another.

For example, the sleeves 62 and 64 are made from plastic.

The apparatus 20 here assumes the form of a preassembled cartridge provided with a case inside which the internal components are arranged that ensure the thermostatic control. The apparatus 20 here is made using a known thermostatic cartridge described in patent FR 2,869,087 in the name of the company VERNET SA.

The turbine 26 is secured to the second sleeve 64. The sleeve 64 also incorporates the second temperature sensor 24, and optionally, the first temperature sensor 22.

The first sleeve 62 includes an end portion 63 that delimits an inner housing V12. In other words, the housing V12 is delimited by a portion of the body of the control device. The housing V12 [is] tightly protected from the streams of fluid Fmix, Fcold, Fhot. The circuit 28 is housed inside this housing V12. For example, the board 45 is mounted on the bottom of the housing V12.

The connection 36 is arranged inside the sleeves 62 and 64. As previously indicated, the connection 36 can either be inserted into a housing prepared to that end during the construction of the sleeves 62 and 64, or be integrated inside sleeves 62 and 64 by overmolding during the construction of the sleeves 62 and 64.

Preferably, a sealing gasket 66, for example an O-ring made from an elastomeric material, is positioned at the junction between the end portion 63 and the rest of the sleeves 62, so as to ensure water tightness.

Similarly, sealing elements, not illustrated, are arranged at the junction of the sleeves 62 and 64 to prevent the fluid from coming into contact with the connection 36.

The end portion 63 serves as support to mount the rotary button 12. However, the end portion 63 does not rotate with the button 12 and remains secured with no degree of freedom with the rest of the body 62.

Conversely, the end portion 63 is passed through by a coupling portion that connects the rotary button 12 with a rotary control member of the apparatus 20, so as to ensure the mechanical coupling between the rotary button 12 and the apparatus 20. The central orifice of the board 45 is passed through by this coupling portion.

Aside from these construction differences, everything that has previously been described in reference to the operation of the circuit 28 and the sensors 22, 24 and 26 can be transposed to this embodiment.

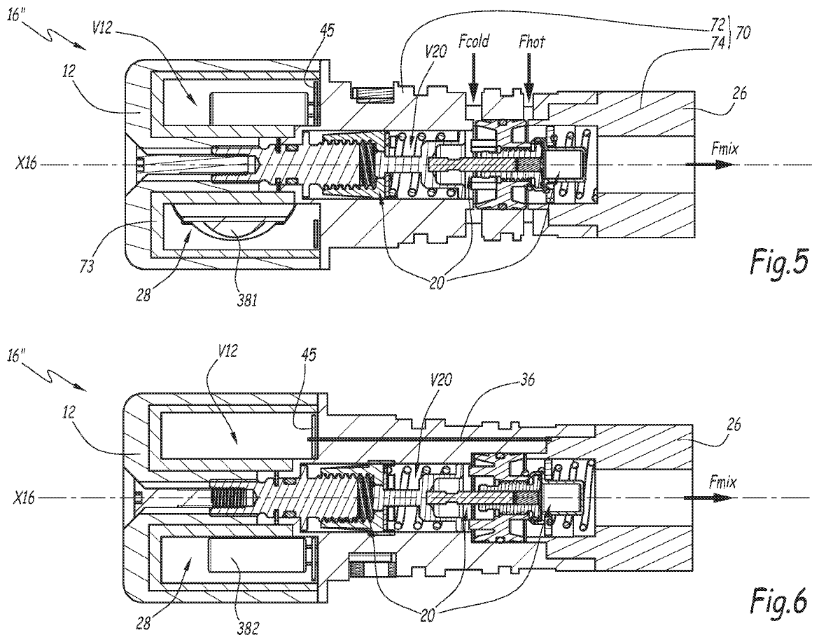

FIGS. 5 and 6 show a thermostatic control device 16′ according to a second specific embodiment of the invention.

The elements of the thermostatic control device 16″ that are similar to one of the embodiments of the thermostatic control device previously described bear the same references and are not described in detail, inasmuch as the above description can be transposed to them.

More specifically, FIGS. 5 and 6 correspond to longitudinal sectional views of the device 16″ in different section planes.

The body of the device 16″ here bears reference 70. The body 70 includes a first sleeve 72 and a second sleeve 74. The sleeves 72 and 74 are secured to one another and are positioned coaxially relative to the axis X16.

Similarly, sealing elements, not illustrated, are arranged at the junction between the sleeves 72 and 74 to prevent fluid from coming into contact with the connection 36.

The second sleeve 74 incorporates the turbine 26 and the second temperature sensor 24. The sleeves 74 is said to be an instrumented sleeve.

Similarly to the sleeve 62 of the device 16′ previously described, the sleeve 72 delimits an inner housing V12 inside which the circuit 28 is housed. Here again, in the illustrated example, the central orifice of the board 45 is passed through by the coupling portion previously defined. Other arrangements are, however, possible.

Furthermore, the sleeve 72 delimits an inner volume V20 intended to receive the apparatus 20.

The inner components forming the apparatus 20 and which ensure the thermostatic control and the mixing of fluids here are distributed directly inside the volume V20. In other words, unlike the case of the device 16′ previously described, the apparatus 20 here is not in the form of a preassembled cartridge.

The role and the operation of these components are well known and are not described in more detail hereinafter. They are for example described in patent FR 2,869,087 in the name of the company VERNET SA.

For example, the sensor 22 is housed in the sleeve 72.

Aside from these construction differences, everything that has previously been described in reference to the operation of the circuit 28 and the sensors 22, 24 and 26 can be transposed to this embodiment.

According to another embodiment, not illustrated, it is the second sleeve 74 that defines the volume V20 and that accommodates the components of the apparatus 20. The dimensions of the sleeves 72 and 74 are adapted accordingly. In particular, the second sleeve 74 here is longer than the first sleeve 72.

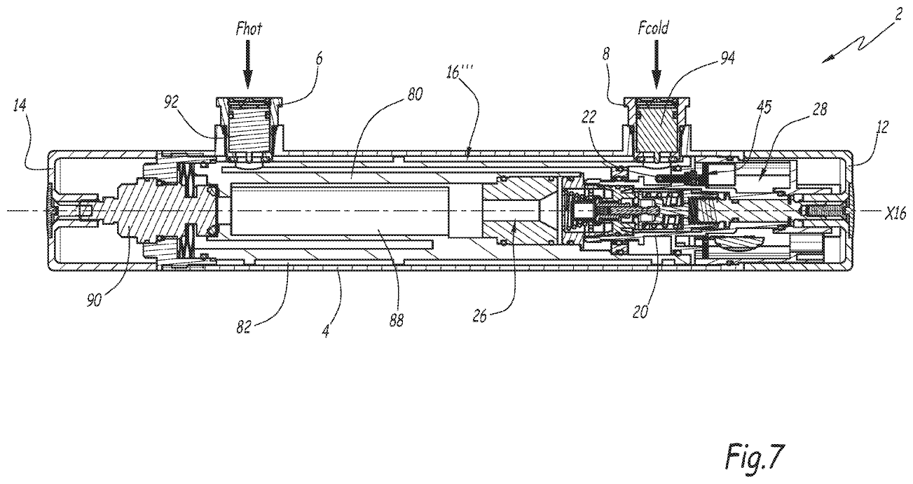

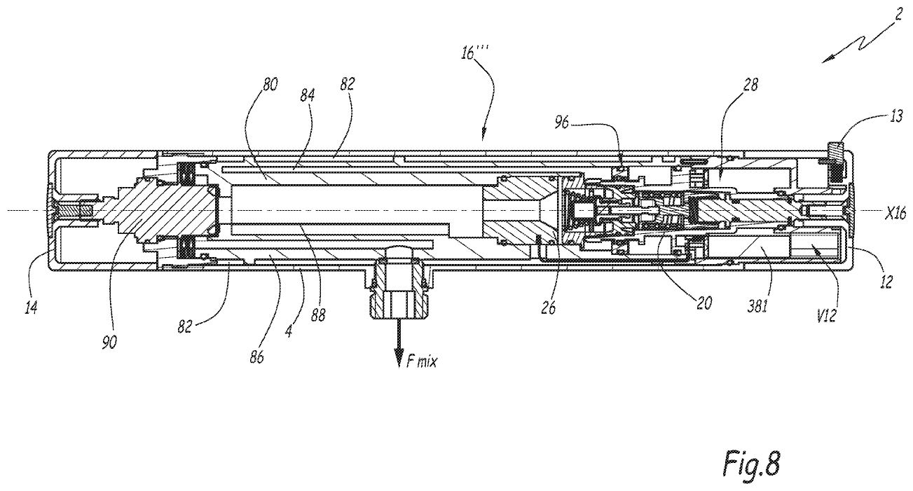

FIGS. 7 and 8 show a thermostatic control device 16′ according to a third specific embodiment of the invention.

The elements of the thermostatic control device 16′″ that are similar to one of the embodiments of the thermostatic control device previously described bear the same references and are not described in detail, inasmuch as the above description can be transposed to them.

More specifically, FIGS. 7 and 8 correspond to longitudinal sectional views of the device 16′″ in different section planes, the device 16′″ being integrated within a thermostatic assembly that is in turn integrated into a mixer tap 2 body 4.

In this example, the device 16′″ is directly integrated within an assembly including a main body 80 and also including a control device of the fluid flow rate, which here bears reference 90. The body 80 here has an essentially cylindrical shape extending along the axis X16. For example, the body 80 is made from plastic.

In the illustrated example, the device 90 is positioned at one end of the body 80 and is coupled with the button 14, while the device 16′″ is positioned at an opposite end of the body 80 and is coupled with the button 12. More specifically, the control member of the apparatus 20 is coupled to the button 12 by means of a coupling portion.

The body 80 is separated from the inner walls of the body 4 by a dry area 82, that is to say, an area through which no fluid can pass under normal operating conditions of the tap 2. For example, the area 82 is filled with air.

For example, one or the other of the inlets 6 and 8 of the tap 2 is positioned across from a corresponding fluid inlet of the device 16′″, to create a direct fluid connection, while the other fluid inlet of the tap 2 (in the case at hand, here, the hot fluid inlet 6) is fluidly connected to the corresponding inlet of the device 16′″ by means of an intake channel 84 formed in the body 80.

Similarly, the mixed fluid outlet of the device 16′″ is fluidly connected to the outlet 10 by means of an outlet channel 86 formed in the body 80.

In this way, the different fluid streams can circulate inside the tap 2, between the inlets 6, 8 and the outlet 10 and the device 16′″ without penetrating the area 82.

The turbine 26 is arranged inside the body 80. The outlet of the turbine 26 emerges in a flow area 88 formed in the body 80, for example at the center of this body 80. This area 88 brings the mixed fluid Fmix toward the device 90. At the outlet of the device 90, the fraction of mixed fluid Fmix that is authorized by the device 90 to exit circulates in the channel 86. In other words, the channel 86 emerges at the outlet of the device 90.

The connection 36 is advantageously arranged in the area 82. In this way, the connection 36 cannot come into contact with the fluids. In other words, the tightness and the protection of the connection 36 are ensured intrinsically.

In this example, the fluid inlets 6 and 8 are respectively each provided with a backflow valve 92 and 94. Reference 96 designates a spacer separating the hot and cold fluid inlets at the apparatus 20. In this embodiment, the apparatus 20 can be made either in the form of a cartridge similar to that previously defined, or by directly incorporating the internal control components within the body 80.

Aside from these construction differences, everything that has previously been described in reference to the operation of the circuit 28 and the sensors 22, 24 and 26 can be transposed to this embodiment.

This third embodiment can be implemented independently of the previous embodiments. In particular, this third embodiment can be implemented with a thermostatic control device that is not instrumented, that is to say, a thermostatic control device similar to the device 16, but in which the circuit 28 and the sensors 22, 24, 26 as well as the connection 36 are omitted.

Thus, the embodiments of the invention make it possible to obtain a particularly advantageous instrumented thermostatic control device. Because the circuit 28 is integrated into the device 16, it is not necessary to modify the bulk of the tap 2, which facilitates its integration into an existing sanitation installation. The presence of the circuit 28 is transparent for the user of the tap 2. It in particular does not alter the thermostatic control. The exchange of data is done solely owing to the wireless means, which avoids having to connect hardwired connections at the tap, since this would pose integration and user safety issues. The tightness arranged at the circuit 28 and the connection 36 limits the risk of damage to the electronics from the fluid circulating in the device 16 and also reduces the risk of electrocution of the users of the tap 2.

According to other embodiments, not illustrated, the electronic circuit 28 is inside the body 80, for example between the cartridge 20 and the device 90. In other words, the connections between the circuit 28 and the sensors are not necessarily placed in tight areas and can be in an area exposed to the fluid. In this case, the electrical connections are preferably ensured tightly, for example owing to sealing gaskets and/or sealed connectors.

The embodiments and alternatives and embodiments considered above may be combined to create new embodiments.

1.-15. (canceled)

16. A thermostatic control device for a thermostatic mixer tap, the control device being configured to produce a mixed fluid stream from a hot fluid stream and a cold fluid stream, wherein the control device is instrumented, the control device comprising:
a temperature sensor for measuring the temperature of the mixed fluid;
a flow rate sensor for measuring a flow rate of the stream of mixed fluid when the control device is in a flowing state; and
an electronic processing circuit, embedded in the control device and comprising:
a programmable electronic computer,
a communication interface provided with a radio antenna,
an electric energy reserve, capable of powering the electronic computer and the communication interface;
wherein the electronic processing circuit is configured to collect information measured by the sensors and transmit the information to outside the control device via the communication interface.

17. The thermostatic control device according to claim 16, wherein the flow rate sensor is a hydraulic turbine suitable for electrically powering the energy reserve, such as an axial micro-turbine.

18. The thermostatic control device according to claim 16, wherein the thermostatic control device includes a hydraulic turbine, such as an axial micro-turbine, suitable for electrically powering the energy reserve and wherein the flow rate sensor is separate from said hydraulic turbine.

19. The thermostatic control device according to claim 16, wherein the communication interface is compatible with a short-range wireless communication technology.

20. The thermostatic control device according to claim 16, wherein the control device further includes a temperature sensor for measuring the temperature of the cold fluid.

21. The thermostatic control device according to claim 20, wherein the electronic processing circuit is programmed to calculate the energy necessary to heat a volume of cold fluid upstream from the thermostatic control device in particular as a function of the measured flow rate, the temperature of the mixed fluid and the temperature of the cold fluid measured by said temperature sensor.

22. The thermostatic control device according to claim 16, wherein the electronic processing circuit is programmed to calculate the energy necessary to heat a volume of cold fluid upstream from the thermostatic control device in particular as a function of the measured flow rate, the temperature of the mixed fluid and a predefined temperature value of the cold fluid.

23. The thermostatic control device according to claim 16, wherein the energy reserve includes one or several supercapacitors.

24. The thermostatic control device according to claim 16, wherein the electronic circuit is at least partially housed inside an inner housing delimited by a body of the control device, this housing being tightly protected from the fluid streams.

25. The thermostatic control device according to claim 16, wherein the information transmitted by the electronic circuit comprises usage data selected from the group consisting of:
evolution of the mixed fluid temperature over time, coming from the measurement by the temperature sensor;
sending of an alert if the mixed fluid temperature exceeds a predefined threshold;
evolution of the mixed fluid flow rate coming from the measurement by the flow rate sensor;
sending of an alert if the mixed fluid flow rate exceeds a predefined threshold;
thermal power provided by an associated hot fluid production device in order to heat the cold fluid;
thermal energy corresponding to the thermal power provided by the production device during a usage cycle of the tap;
an estimate of the financial cost associated with the production of the thermal energy for the usage cycle;
start and/or end date and time of the usage cycle;
duration of the usage cycle;
average, minimum and maximum values of the mixed fluid temperature during the usage cycle;
average, minimum and maximum values of the mixed fluid flow rate during the usage cycle; and
volume of water consumed during the usage cycle.

26. The thermostatic control device according to claim 16, wherein the electronic computer is programmed to store, in permanent memory, statistical data representative of the use of the tap.

27. A thermostatic control assembly for a thermostatic mixer tap, the assembly comprising:
a thermostatic control device according to claim 16; and
a flow rate controller configured to control the mixed fluid flow rate.

28. A thermostatic mixer tap, comprising:
a mixer tap body;
a hot fluid inlet, a cold fluid inlet and a mixed fluid outlet; and
a thermostatic control device according to claim 16 positioned inside the body and fluidly connected to the fluid inlets and the fluid outlet.

29. The thermostatic control tap according to claim 28, wherein the control device is integrated into an assembly including a main body and a control device of the fluid flow rate, the assembly being positioned inside the tap body coaxially with this tap body, wherein the main body is separated from the inner walls of the tap body by a dry area, and wherein the device comprises an electrical connection that connects the electronic circuit to the sensors, this electrical connection being positioned in the dry area.

30. The thermostatic control tap according to claim 28, wherein the control device is integrated into an assembly including a main body and a control device of the fluid flow rate, the assembly being positioned inside the tap body, and wherein the electronic processing circuit associated with the control device is inside the main body.
